(19) United States
(12) Patent Application Publication
(10) Pub. No.: US 2009/0001057 A1
(43) Pub. Date: Jan. 1, 2009

(54) Dual damascene trench depth detection and control using voltage impedance RF probe

(76) Inventors: Cheng-Hsin Ma, San Jose, CA (US); Jeff J. Xu, San Jose, CA (US)

Correspondence Address: CAVEN & AGHEVLI;c/o INTELLEVATE, LLC, P.O. BOX 52050, MINNEAPOLIS, MN, 55402, US

(21) Appl. No.: 11/824,503

(22) Filed: Jun. 29, 2007

(51) Int. Cl. B23K 10/00

(52) U.S. Cl. 219/121.41; 219/121.4

(57) ABSTRACT

In one embodiment, a system to measure changes and a dual damascene trench depth, comprises a power source, and impedance matching network coupled to the power source and to an electrode, a radio frequency sensor coupled to the impedance matching network, and a controller to establish a baseline correlation between a plasma impedance and the dual damascene trench depth, and use the baseline correlation to measure changes in the dual damascene trench depth.

### BACKGROUND

The subject matter described herein relates generally to semiconductor processing, and to dual damascene trench depth detection and control using a broadband voltage-current (V-I) probe.

Dual Damascene trench depth needs to be managed and controlled. Trench depth variation will cause performance issues for semiconductor devices due to an imbalance between resistance and capacitance. This resistance and capacitance imbalance may cause circuit timing issues due to RC delay, thereby leading to degraded device performance and die yield/line yield loss in some extreme case like stop layer punch-through. Therefore, techniques to reliably detect and control the dual damascene trench depth may find utility to improve both device performance and die/line yield.

### BRIEF DESCRIPTION OF THE DRAWINGS

The disclosed embodiments will be better understood from a reading of the following detailed description, taken in conjunction with the accompanying Figures in the drawings in which:

FIG. 1 is a schematic illustration of a system for dual damascene trench depth analysis, according to embodiments.

FIG. 2 is a flowchart illustrating operations in a method for dual damascene trench depth analysis, according to embodiments.

FIG. 3 is a schematic illustration of changes in impedance properties as a dual damascene trench depth various, according to embodiments.

FIG. 4 is a schematic illustration of changes in impedance properties as a dual damascene trench depth various, according to embodiments.

For simplicity and clarity of illustration, the drawing Figures illustrate the general manner of construction, and descriptions and details of well-known features and techniques may be omitted to avoid unnecessarily obscuring the discussion of the described embodiments of the invention. Additionally, elements in the drawing Figures are not necessarily drawn to scale. For example, the dimensions of some of the elements in the Figures may be exaggerated relative to other elements to help improve understanding of embodiments of the present invention. The same reference numerals in different Figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method. Furthermore, the terms “comprise,” “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used.

### DETAILED DESCRIPTION

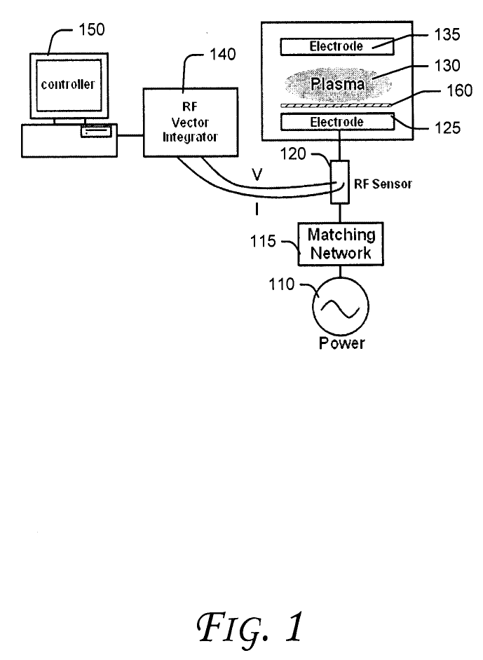

FIG. 1 is a schematic illustration of a system for dual damascene trench depth analysis, according to embodiments. Referring to FIG. 1, the system comprises a power source 110 and a matching network 115 coupled to the power source 110. The matching network 115 is coupled to a first electrode 125, which is displaced from a second electrode 135. Plasma 130 is disposed between electrode 125 and electrode 135. The etched wafer (160) can be on the top of either electrode (125, 135)

In some embodiments a broadband V-I sensor 120 is coupled to the impedance matching network 115. broadband V-I sensor 120 is coupled to a radio frequency vector integrator our module 140, which is in turn coupled to a controller 150. Controller 150 may be embodied as a conventional computing devices such as, for example, a personal computer.

In some embodiments, the system utilizes the fact that the measured harmonics of impedance from a radio frequency system like a plasma etcher are sensitive to slight impedance changes in the radio frequency system. Therefore, amounts of oxide materials removed during Dual Damascene etch can be detected through measuring an impedance change in a plasma etcher. The impedance change occurs is because the oxide removal during dual damascene trench formation causes the capacitance change and therefore the overall etcher's impedance change. By establishing a correlation between the dual damascene trench depth and the etcher's impedance, in-situ trench depth detection and control may be realized by measuring the etcher's impedance change.

FIG. 1 depicts the integration of a broadband V-I probe and an RF plasma system. As shown in the diagram, an external broadband V-I sensor connected between the plasma matching network and a bottom electrode. By analyzing the plasma impedance (through voltage, current and phase angle signals) changes during etch, one is able to correlate the impedance change to the dual damascene trench depth.

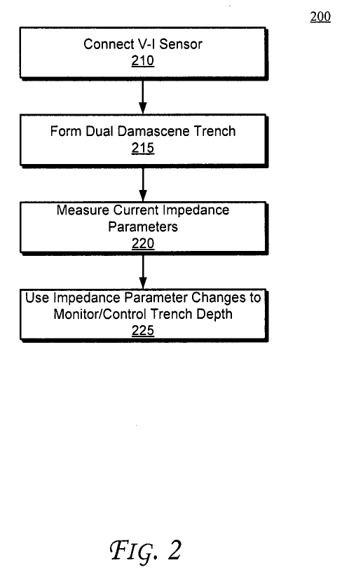

FIG. 2 is a flowchart illustrating operations in a method for dual damascene trench depth analysis, according to embodiments. Referring to FIG. 2, at operation 210 a broadband V-I sensor is connected to a matching network, for example, as illustrated in FIG. 1. At operation 215, a dual damascene trench is formed in the semiconductor structure. At operation 220 current impedance parameters are measured, e.g., using the V-I sensor, in the dual damascene trench. At operation 225 the impedance parameter changes are used to monitor/control the depth of the dual damascene trench. For example, in some embodiments impedance measurements such as, for example, a voltage, current, and/or phase change measurement may be taken in dual damascene trench structures having known trench depths. Impedance measurement data collected during this process may be stored in a suitable memory location such as, for example, memory coupled to controller 150. The collected impedance measurement data may be used in subsequent processing operations to determine a depth of a dual damascene trench.

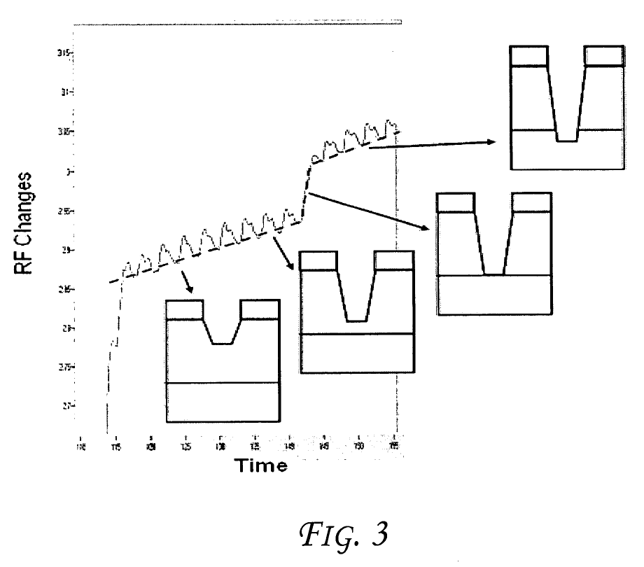

FIG. 3 is a schematic illustration of changes in impedance properties as a dual damascene trench depth various, according to embodiments of the invention. Referring to FIG. 3, it can be seen that the plasma impedance changes in correlation with the depth of the dual damascene trench. Also the transition of impedance indicate the etched material change.

Referring back to FIG. 2, at operation 220 dual damascene trench is formed. The dual Damascene trench may be formed using any conventional semiconductor processing technique. For example, a selective etching process may be implemented. At operation 225 one or more impedance parameters are measured during construction of the dual Damascene trench. For example, in some embodiments impedance measurements such as, for example, a voltage, current, and/or phase change measurement may be taken in dual damascene trench structures having known trench depths. In some embodiments,

At operation 230, the voltage, current, and/or phase change parameters are used to determine a measure of the dual damascene trench. In some embodiments the voltage, current, and/or phase change parameters may be compared to the baseline voltage, current, and/or phase change correlation parameters obtained in operation 215. For example, one or more interpolation techniques may be implemented to determine a trench depth from the voltage, current, and/or phase change parameters and the baseline parameters established in operation 215.

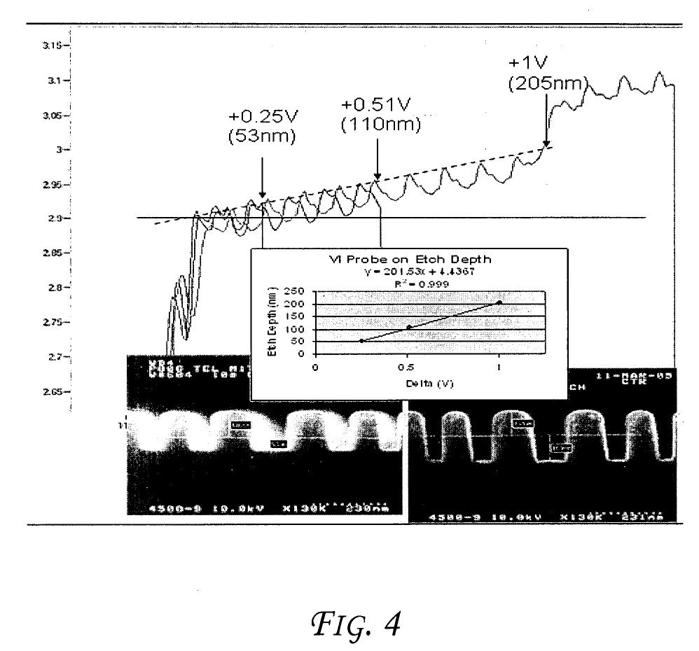

FIG. 4 is a schematic illustration of changes in voltage properties as a dual damascene trench depth various, according to embodiments of the invention. More particularly, FIG. 4 depicts a correlation between one of the harmonic voltage change of a V-I signal and dual damascene trench depth with linear fitting accuracy R²=0.999. Therefore, a dual damascene trench depth could be monitored and controlled through measuring the V-I signal.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” “some embodiments” or “an embodiment” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method to measure changes in a dual damascene trench depth, comprising:
establishing a baseline correlation between a plasma impedance and the dual damascene trench depth;
using the baseline correlation to measure changes in the dual damascene trench depth.

2. The method of claim 1, wherein establishing a baseline correlation between a plasma impedance and a dual damascene trench depth comprises connecting an external broadband V-I sensor between a plasma matching network and an electrode.

3. The method of claim 2, wherein the external broadband V-I sensor comprises a broadband V-I probe.

4. The method of claim 3, wherein establishing a baseline correlation between a plasma impedance and a dual damascene trench depth comprises measuring a voltage, current, and/or phase change of one of the harmonic detected by the broadband V-I probe.

5. The method of claim 1, wherein establishing a baseline correlation between a plasma impedance and a dual damascene trench depth comprises measuring at least one of a voltage, current, and phase changes during an etching process.

6. The method of claim 1, wherein using the baseline correlation to measure changes in the dual damascene trench depth comprises:
measuring at least one of a voltage, current, and phase changes during an etching process; and
comparing at least one of a voltage, current, and phase changes during the etching process to at least one baseline data.

7. A system to measure changes and a dual damascene trench depth, comprising:
a power source;
an impedance matching network coupled to the power source and to an electrode;
a broadband V-I sensor coupled to the impedance matching network; and
a controller to:
establish a baseline correlation between a plasma impedance and the dual damascene trench depth; and
use the baseline correlation to measure changes in the dual damascene trench depth.

8. The system of claim 7, wherein, the broadband V-I sensor comprises a broadband V-I probe.

9. The system of claim 7, wherein the controller measures a voltage, current, and/or phase change of one or multi harmonic detected by the broadband V-I probe.

10. The system of claim 7, wherein the controller measures at least one of a voltage, current, and phase changes during an etching process.

11. The system of claim 7, wherein the controller:
measures at least one of a voltage, current, and phase changes during an etching process; and
compares at least one of a voltage, current, and phase changes during the etching process to at least one baseline data.
